(19) United States
(12) Patent Application Publication
(10) Pub. No.: US 2006/0175318 A1
(43) Pub. Date: Aug. 10, 2006

(54) Shield for insulating glass oven emitter

(75) Inventors: Timothy B. McGlinchy, Twinsburg, OH (US); William A. Briese, Hinckley, OH (US)

Correspondence Address: BROUSE MCDOWELL LPA, 388 SOUTH MAIN STREET, SUITE 500, AKRON, OH, 44311, US

(73) Assignee: GLASS EQUIPMENT DEVELOPMENT, INC.

(21) Appl. No.: 11/348,387

(22) Filed: Feb. 6, 2006

Related U.S. Application Data
(60) Provisional application No. 60/650,742, filed on Feb. 7, 2005.

(51) Int. Cl. H05B 3/06

(52) U.S. Cl. 219/522

(57) ABSTRACT

A glass oven may include an emitter, a glass bearing device for use in bearing a glass product to be heated by the glass oven and a shield supported within the oven and positioned between the emitter and the glass product. In one embodiment, the emitter is an IR emitter and the shield is formed from a quartz tube.

This application claims priority to U.S. Ser. No. 60/650,742, entitled SHIELD FOR INSULATING GLASS OVEN EMITTER, filed Feb. 7, 2005, which is incorporated herein by reference.

### I. BACKGROUND OF THE INVENTION

A. Field of Invention

This invention pertains to the art of methods and apparatuses for glass ovens and more specifically to methods and apparatuses for shielding IR emitters positioned within insulating glass ovens.

B. Brief Description of Background

Construction of insulating glass units (IGUs) generally involves forming a spacer frame by roll-forming a flat metal strip, into an elongated hollow rectangular tube or “U” shaped channel. Generally, a desiccant material is placed within the rectangular tube or channel, and some provisions are made for the desiccant to come into fluid communication with or otherwise affect the interior space of the insulating glass unit. The elongated tube or channel is notched to allow the channel to be formed into a rectangular frame. Generally, a sealant is applied to the outer three sides of the spacer frame in order to bond a pair of glass panes to either opposite side of the spacer frame. Existing heated sealants include hot melts and dual seal equivalents (DSE). A pair of glass panes is positioned on the spacer frame to form a pre-pressed insulating glass unit. Generally, the pre-pressed insulating glass unit is passed through an IGU oven to melt or activate the sealant. The pre-pressed insulating glass unit is then passed through a press that applies pressure to the glass and sealant and compresses the IGU to a selected pressed unit thickness.

Manufacturers may produce IGUs having a variety of different glass types, different glass thicknesses and different overall IGU thicknesses. The amount of heat required to melt the sealant of an IGU varies with the type of glass used for each pane of the IGU. Generally, the heat within the IGU oven is provided by Infrared (IR) emitters. The IR emitters are usually positioned both above and below the IGU as it passes through the IGU oven. The IR emitters may be constructed from a hermetically sealed longitudinal chamber of quartz, which is typically a pure quartz. “Pure quartz” is a phrase meaning quartz not having a significant amount of impurities. The IR emitters include a filament that may last for upwards of 5000 hours of operation or more, based in part on the hermetically sealed quartz chamber.

As the IGUs or other glass products move through the glass oven, glass may periodically break creating chards or pieces of glass that may fall on the surface of the quartz-encased IR emitter. Alternately, other types of debris such as dust or other particulate contaminants may also come to rest on the outer surface of the IR emitters. The outer surface of IR emitters can reach temperatures in excess of 3000 degrees Fahrenheit. As a result, when this debris lands on the IR emitter surface, it may subsequently melt and/or bake into the outer quartz chamber and may also melt through the quartz chamber thereby breaching the hermetically sealed emitters. Once an IR emitter outer chamber has been breached, the life of the filament is greatly reduced. As IR emitters are expensive to replace, a solution is needed to prevent debris from landing on the surface of the IR emitters. The present invention greatly minimizes the problems described above.

### II. SUMMARY OF THE INVENTION

According to one aspect of this invention, an emitter is shielded with a shield that is positioned between the emitter and the location within the glass oven occupied by a glass product that is to be heated by the glass oven. The emitter may be supported by a first clamp assembly. A first shield support structure may be used to support the shield and may support the shield to the clamp assembly.

According to another aspect of this invention, the emitter may be an IR emitter and the shield may be formed substantially of quartz.

According to another aspect of this invention, the shield support structure may include an opening that at least partially receives the IR emitter and a pair of support surfaces positioned on opposite sides of the shield.

According to another aspect of this invention, the shield may be formed from a quartz tube. In another embodiment, a quartz tube may be cut down its longitudinal center to form a pair of shields.

According to another aspect of this invention, the shield can be easily added to the glass oven. First, the shield support structure may be attached to the oven. In one embodiment, the shield support structure is attached to the clamp assembly used to support the IR emitter. The shield can then be easily placed onto the shield support structure. Should the shield become damaged or otherwise need to be replaced, it is easy to lift from the support structure. A new shield can then easily be placed onto the shield support structure.

### III. BRIEF DESCRIPTION OF THE DRAWINGS

The invention may take physical form in certain parts and arrangement of parts, one or more embodiments of which will be described in detail in this specification and illustrated in the accompanying drawings which form a part hereof and wherein:

FIG. 1 is a perspective view of an insulating glass unit (IGU).

FIG. 2 is a sectional view taken across lines 2-2 of FIG. 1.

FIG. 3 is a sectional view of an insulating glass unit prior to pressing of the sealant to achieve the insulating glass unit of FIG. 2.

FIG. 4 is a top plan view of an apparatus for heating and pressing sealant of an insulating glass unit.

FIG. 5 is a side elevation view of the apparatus for heating and pressing sealant of an insulating glass unit shown in FIG. 4.

FIG. 6 is a perspective side view of a glass oven with the top portion raised to show the emitters.

FIG. 7 is a close-up perspective side view of the glass oven of FIG. 6 showing the IR emitters and the rollers.

FIG. 8 is an end view of a pair of IR emitters positioned within a glass oven and showing a shield positioned between the lower IR emitter and the location occupied by a glass product that is to be heated by the glass oven.

FIG. 9 is a side view of the lower IR emitter of FIG. 8.

FIG. 10 is perspective side view showing a shield support structure connected to a pair of clamp assemblies that are supporting a section of an IR emitter.

FIG. 11 is perspective end view of the apparatus in FIG. 10 showing the support surfaces of the shield support structure.

### IV. DETAILED DESCRIPTION OF THE INVENTION

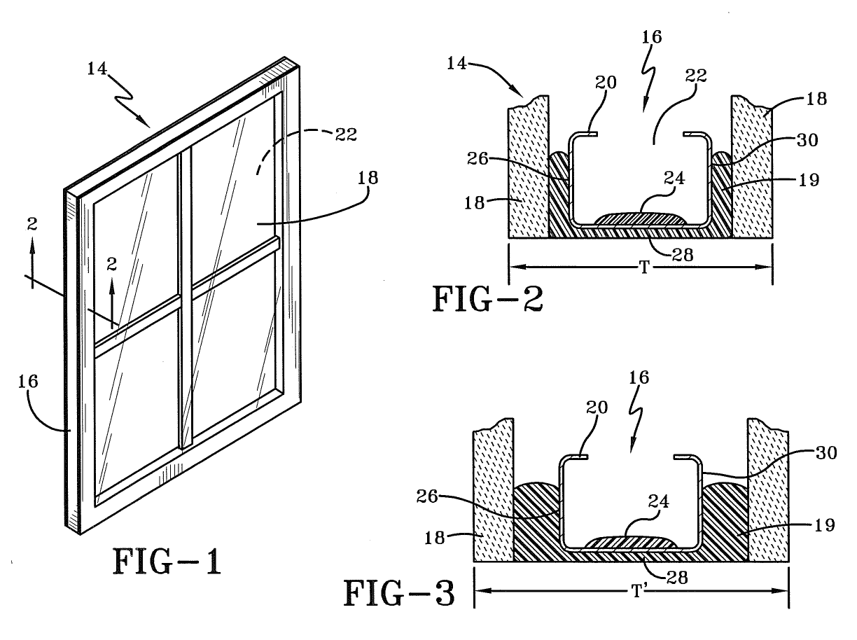

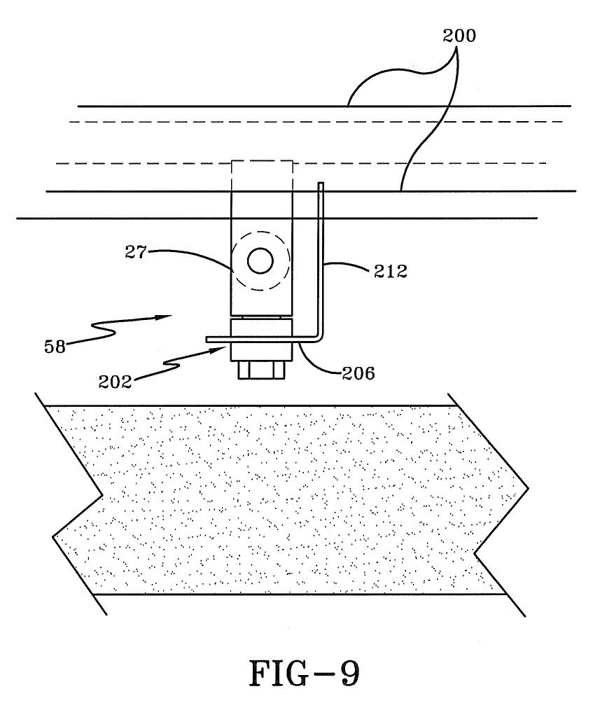

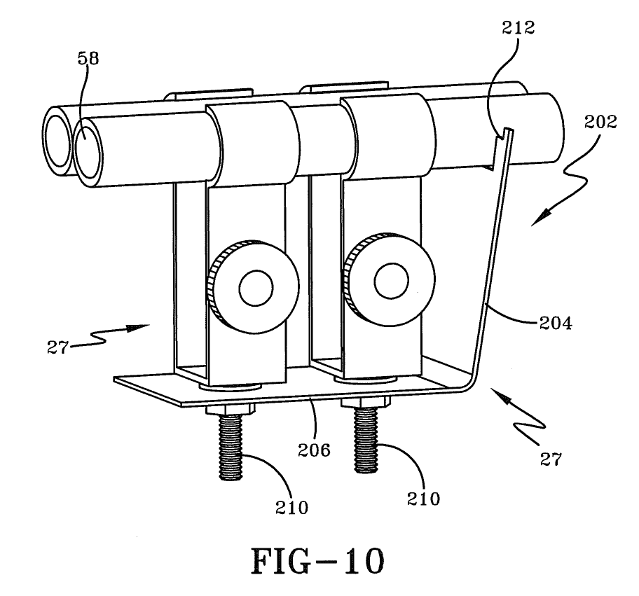

Referring now to the drawings wherein the showings are for purposes of illustrating a preferred embodiment of the invention only and not for purposes of limiting the same, FIGS. 4 and 5 illustrate an apparatus 10 used to make an insulating glass unit IGU or other glass product 14. The apparatus 10 includes an oven 32 that includes a shield 200, shown best in FIGS. 8 and 9, according to this invention. One type of insulating glass unit 14 that may be constructed with the apparatus 10 is illustrated in FIGS. 1 and 2 and includes a spacer assembly 16 sandwiched between glass sheets or lites 18. The illustrated spacer assembly 16 includes a frame structure 20, a sealant material 19 for hermetically joining the frame to the lites 18 to form a closed space 22 within the IGU 14 and a body of desiccant 24 positioned within the space 22. The IGU 14 illustrated by FIG. 1 is in condition for final assembly into a window or door frame, not illustrated, for installation in a building. It is also contemplated that the disclosed apparatus may be used to construct an insulating window with panes bonded directly to sash elements of the window, rather than using an IGU that is constrained by the sash. It should be apparent that the disclosed oven 32 and method can be used to heat sealant in insulating glass units having any shape and size and can be used with other glass products as well.

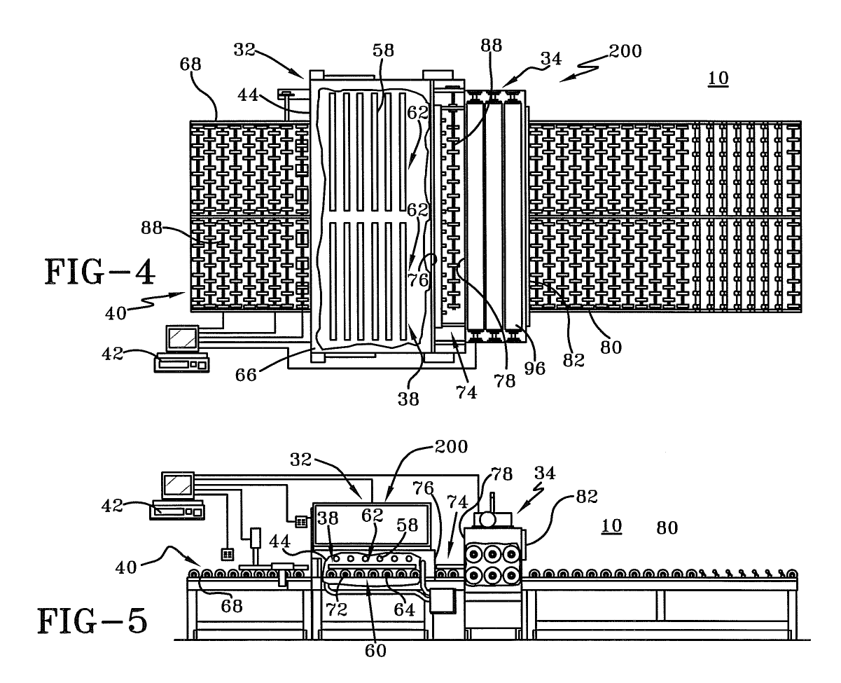

With reference to FIGS. 1-3, the glass lites 18 may be constructed from any suitable or conventional glass. The spacer assembly 16 functions to maintain the lites 18 spaced apart from each other and to produce the hermetic insulating dead air space 22 between the lites 18. The frame 16 and sealant 19 co-act to provide a structure which maintains the lites 18 properly assembled with the space 22 sealed from atmospheric moisture over long time periods during which the insulating glass unit 14 is subjected to frequent significant thermal stresses. The desiccant body 24 serves to remove water vapor from air or other gases entrapped in the space 22 during construction of the insulating glass unit and any moisture that migrates through the sealant over time.

With continuing reference to FIGS. 1-3, the sealant 19 both structurally adheres the lites 18 to the spacer assembly 16 and hermetically closes the space 22 against infiltration of air born water vapor from the atmosphere surrounding the IGU 14. A variety of different sealants may be used to construct the IGU 14. Examples include hot melt sealants, dual seal equivalents (DSE), and modified polyurethane sealants. Although a hot melt sealant is disclosed, other suitable or conventional substances (singly or in combination) for sealing and structurally carrying the unit components together may be employed.

Still referring to FIGS. 1-3, the illustrated frame 20 is constructed from a thin ribbon of material, such as plastic or metal. The metal may be, for example, stainless steel, tin plated steel or aluminum. The ribbon is passed through forming rolls (not shown) to produce walls 26, 28, 30. In the illustrated embodiment, the desiccant 24 is attached to an inner surface of the frame wall 26. The desiccant 24 may be formed by a desiccating matrix in which a particulate desiccant is incorporated in a carrier material that is adhered to the frame. The carrier material may be silicon, hot melt, polyurethane or other suitable material. The desiccant absorbs moisture from the surrounding atmosphere for a time after the desiccant is exposed to atmosphere. The desiccant absorbs moisture from the atmosphere within the space 22 for some time after the IGU 14 is fabricated. This assures that condensation within the unit does not occur. In the illustrated embodiment, the desiccant 24 is extruded onto the frame 20. To form an IGU 14 the lites 18 are placed on the spacer assembly 16. The IGU 14 is then heated and pressed together to bond the lites 18 and the spacer assembly 16 together.

With reference now to FIGS. 4 and 5, the illustrated apparatus 10 for heating and pressing sealant 19 of an IGU 14 includes the oven 32 for heating the sealant 19 of an IGU 14 and a press 34 for applying pressure to the sealant 19 and compressing the IGU 14 to the desired thickness T (shown in FIG. 2). The operation of the apparatus 10 is disclosed in U.S. Pat. No. 6,926,782 titled “Method and Apparatus for Processing Sealant of an Insulating Glass Unit” which is incorporated herein by reference and which is assigned to the same entity as this application, Glass Equipment Development, Inc. As a result, many details concerning the control and operation of the apparatus 10 and its components will not be provided here.

With continuing reference to FIGS. 4 and 5, the illustrated oven 32 includes an energy source 38, a conveyor 40 and a controller 42. The energy source 38 applies energy to the IGU 14 to heat or activate the sealant 19. The conveyor 40 moves the IGU or other glass product 14 with respect to the energy source 38. The controller 42 may control the amount of energy supplied by the energy source 38 to the IGU 14 and the speed of the conveyor 40. The conveyor 40 includes four sections that move IGUs 14 through the apparatus 10 for heating the sealant 19. The sections include an inlet conveyor 68 that supplies IGUs 14 to an inlet 44 of the oven 32, an oven conveyor 72 that moves IGUs 14 through the oven 32, a transition conveyor 74 that moves IGUs 14 from an outlet 76 of the oven 32 to an inlet 78 of the press 34, and an outlet conveyor 80 that moves pressed IGUs 14 away from the outlet 82 of the press 34. It should be readily apparent to those skilled in the art that any suitable controller and conveyor configuration could be employed.

Still referring to FIGS. 4 and 5, the illustrated energy source 38 comprises a plurality of emitters 58, sometimes known as heat lamps. It should be understood that this invention works well with any type of emitter 58 chosen with sound engineering judgment including ultraviolet UV emitters or, preferably, IR emitters. As illustrated in FIG. 5, there are two side by side lower arrays 60 of IR emitters that extend across a width of an oven housing that supports the IR emitters. Similarly, as seen in the top view of FIG. 4, two side by side upper arrays 62 of IR emitters apply infrared light to heat the IGU from above. In the illustrated embodiment, the lower arrays 60 are adjacent to one another and the upper arrays 62 are adjacent to one another. In the exemplary embodiment, each of the IR emitters 58 are independently controlled. In the illustrated embodiment, each IR emitter 58 of the lower arrays 60 is positioned between the components of a glass bearing device 63 that is used to bear or support the IGU 14 within the oven 32. The glass bearing device 63 shown includes the oven conveyor 72 having a plurality of rollers 64 positioned within of the oven housing 66. Each of the IR emitters 58 of the upper arrays 62 is located in the oven housing 66 above the conveyor 40. The upper and lower arrays on the two sides of the oven may be operated independently of each other. Similarly, the IR emitters 58 on the left side of the oven may be operated independently of the IR emitters 58 on the right side of the oven 32.

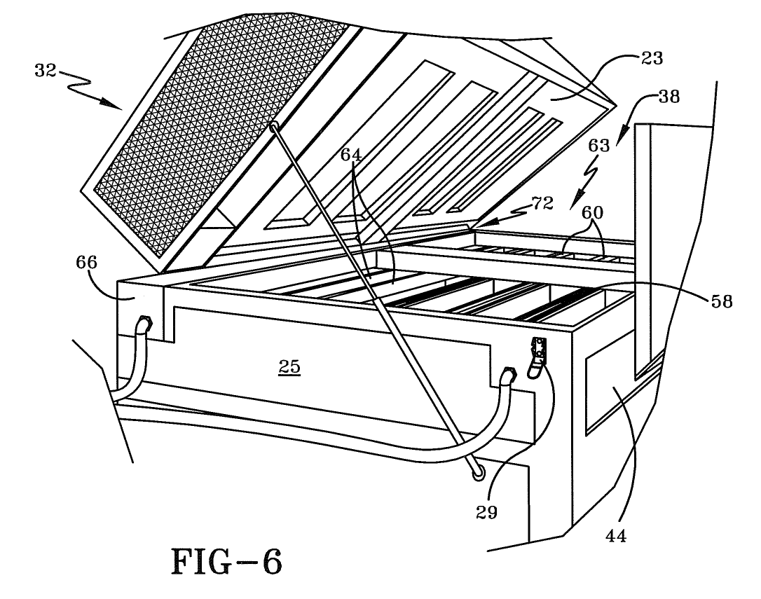

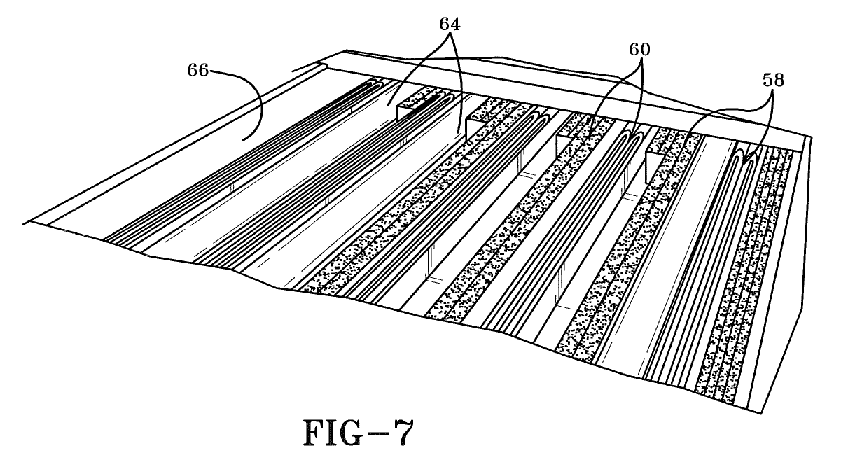

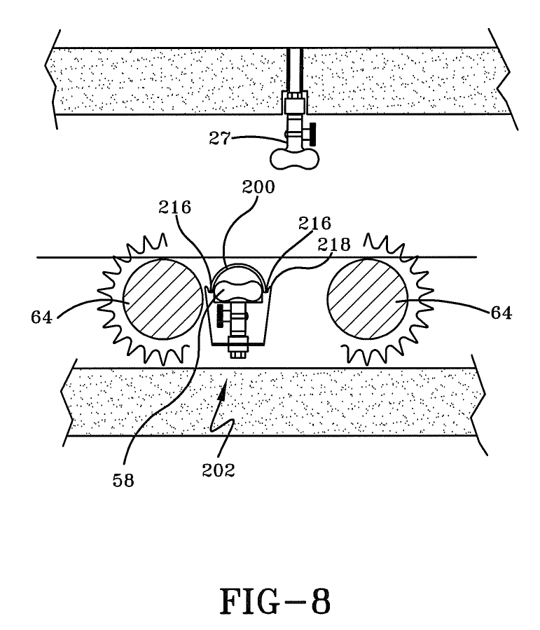

With reference now to FIGS. 6-7, the oven 32 is shown in an open condition. The oven 32 may include a top portion 23 hingingly connected to the lower portion 25 to allow an operator access to the interior of the oven 32. A latch or other securing means 29 may be incorporated to secure the top portion 23 to the lower portion 25. The rollers 64 may extend from one side of the oven 32 to the other and may be formed of a ceramic material. It is noted that the ceramic rollers 64 inherently possess a heat/energy saturation limit without heat-affected memory.

With reference now to FIGS. 8-11, at least one clamp assembly 27 is used to support each IR emitter 58 within the oven 32. The clamp assemblies 27 may permit the IR emitters 58 to be positioned adjusted within the oven 32 both laterally and vertically. In one embodiment, the clamp assembly 27 may have a portion shaped similar to the outside of the IR emitters 58 to securely hold the IR emitters 58 in place. However, it is to be understood that any manner or configuration of clamp assemblies 27 may be chosen with sound engineering judgment as is appropriate for securely holding the IR emitters 58 in place. The clamp assemblies 27 may be constructed from a stainless steel alloy, for purposes described below.

With continuing reference to FIGS. 8-11, the inventive shield 200 is provided to protect the IR emitters 58 from the debris described above. Due to the effect of gravity on the debris, the lower arrays 60 of IR emitters 58 are most vulnerable to the negative impact of the debris. Thus, it may be desirable to only use the shield 200 for the lower IR emitters 58. However, the shield 200 can be used for any emitter positioned anywhere in the oven 32. While the shield 200 may be formed of any material chosen with sound engineering judgment, the shield 200 is preferably formed of substantially pure quartz because any impurities in the quartz will absorb energy thereby limiting the effectiveness of the IR emitters 58. Another advantage of quartz is that the energy radiating from the IR emitters 58 must be transferred through the shield 200 to the glass product 14. Shields 200 made of quartz work well for this purpose. Each shield 200 may extend the entire length of the corresponding IR emitter 58 or may only extend over the length of IR emitter 58 that is most likely to receive debris. The precise portion of IR emitter 58 protected by the shield 200 can be chosen with sound engineering judgment.

With reference now to FIGS. 8-9, in one embodiment, the shield 200 may have a curved cross section. Such a curved cross-section eliminates sharp corners that may prevent even transfer of energy to the glass product 14. In another embodiment, the shield may have a semi-circular cross section, as shown. Alternately, any configuration and shape of shield 200 may be chosen with sound engineering judgment. In one embodiment, each shield 200 is constructed by cutting a quartz tube in half along its longitudinal axis. Such a cut would create the semi-circular cross section for the shield 200. Such a cut may also convert a single quartz tube into two shields. The cutting of the quartz tube may be accomplished via a laser. However, any means of cutting the tube may be chosen with sound engineering judgment as is appropriate for use with the present invention.

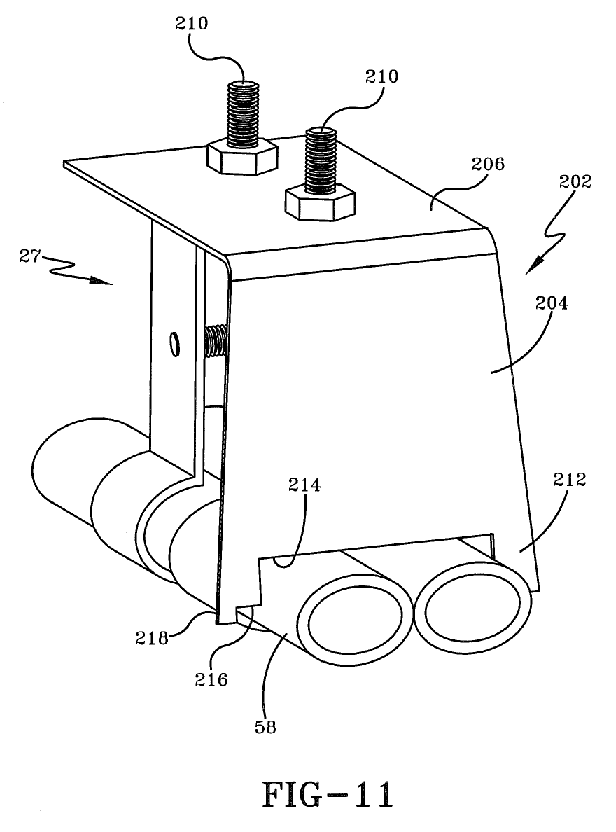

With reference now to FIGS. 8-11, at least a first shield support structure 202 may be used to maintain the shield 200 between the IR emitter 58 and the glass product 14. The shield support structure 202 may be constructed from a stainless steel alloy, such as Inconel. In that the temperature within the oven 32 can be extremely high, the shield support structure 202 needs to be able to maintain shape and rigidity during operation of the oven 32. It is noted however that any alloy or other material that can withstand the temperatures generated within the oven may be used to construct the shield support structure 202. The total number of shield support structures 202 used can vary as needed. In one embodiment, one shield support structure 202 is used for each clamp assembly 27. In another embodiment, shown in FIGS. 10-11, one shield support structure 202 is used with a pair of clamp assemblies 27. The shield support structure 202 may, as shown, support the shield 200 to the clamp assembly 27. In one embodiment, the shield support structure 202 is formed of an L-shaped bracket 204. The bracket 204 may have a first end 206 with at least one hole (two shown) to receive a bolt shaft 210 from the clamp assembly 27. The bracket 204 may also have a second end 212 having an opening 214 that at least partially receives the corresponding IR emitter 58 and a pair of support surfaces 216, 216 positioned on opposite sides of the opening 214 that support opposite sides of the shield 200, as shown. In one embodiment, each support surface 216 may have a lip 218 extending above the support surface 216 to prevent the shield 200 from sliding off the support surface 216. In another embodiment, shown in FIG. 8, each support surface 216 is wider than the corresponding width of the shield 200. The extra space on the support surface 216 permits the shield 200 to thermally expand, without binding, and still remain secure. In another embodiment, each shield 200 may be supported by a support structure not attached to the clamp assembly 27.

In operation, with reference to all the FIGURES, to shield an IR emitter 58 a shield 200 may be supported on shield support structure 202 within the glass oven 32 between the IR emitter 58 and the location occupied by the glass product 14. With the shield 200 thus in place, any debris that may fall or otherwise move toward the IR emitter 58 will be intercepted by the shield 200. As a result, any such debris will not damage the hermetically sealed IR emitters 58, which are substantially more expensive to replace that the shields 200. More specifically, in one embodiment, the shield support structure 202 may be attached to one or more clamp assemblies 27, as described above. The IR emitters 58 may extend, at least partially, within an opening formed in the shield support structure 202. The shield 200 may then be placed on the support surfaces 216, 216 between the lips 218, 218. In this way, the shield 200 may rest gently on the support surfaces 216, 216, as shown in FIG. 8. Accordingly, the shield 200 may not be fixedly secured which makes replacement and handling of the shields 200 very convenient. A more secure attachment of the shield 200 to the shield support structure 202 may be required when the shield 200 is used to protect IR emitters 58 positioned above the glass product 14.

While the invention has been described in combination with embodiments thereof, it is evident that many alternatives, modifications, and variations will be apparent to those skilled in the art in light of the foregoing description. Accordingly, it is intended to embrace all such alternatives, modifications and variations as fall within the spirit and broad scope of the appended claims.

I/We claim:

1. An apparatus comprising:
an emitter;
a first clamp assembly adapted to support the emitter within a glass oven;
a shield; and,
a first shield support structure that maintains the shield between the emitter and a location within the glass oven occupied by a glass product that is to be heated by the glass oven, the first shield support structure also supports the shield to the first clamp assembly.

2. The apparatus of claim 1 wherein the emitter is an IR emitter and the shield is formed substantially of quartz.

3. The apparatus of claim 2 wherein the first shield support structure comprises:
an opening that at least partially receives the IR emitter; and,
a pair of support surfaces positioned on opposite sides of the opening that support opposite sides of the shield.

4. The apparatus of claim 1 further comprising:
a second clamp assembly adapted to support the emitter within the glass oven; and,
a second shield support structure that maintains the shield between the emitter and a location within the glass oven occupied by a glass product that is to be heated by the glass oven, the second shield support structure also supports the shield to the second clamp assembly, the second shield support structure comprising:
(a) an opening that at least partially receives the emitter; and,
(b) a pair of support surfaces positioned on opposite sides of the opening that support opposite sides of the shield.

5. The apparatus of claim 1 further comprising:
a second clamp assembly adapted to support the emitter within the glass oven, the first shield support structure also supporting the shield to the second clamp assembly.

6. The apparatus of claim 3 wherein the shield is formed from a quartz tube.

7. The apparatus of claim 3 wherein the first shield support structure permits the shield to thermally expand on the pair of support surfaces.

8. A glass oven, comprising:
an emitter supported within the oven;
a glass bearing device for use in bearing a glass product to be heated by the glass oven, the glass bearing device being supported within the oven; and,
a shield supported within the oven and positioned between the emitter and the glass product.

9. The glass oven of claim 8 wherein the emitter is an IR emitter and the shield is formed substantially of quartz.

10. The glass oven of claim 9 wherein the shield has a curved cross-sectional shape.

11. The glass oven of claim 10 wherein the shield is formed from a quartz tube.

12. The glass oven of claim 9 further comprising:
a shield support structure that supports the shield and permits the shield to thermally expand without binding.

13. The glass oven of claim 9 further comprising:
a first clamp assembly that supports the IR emitter to the glass oven; and,
a first shield support structure that supports the shield to the clamp assembly.

14. The glass oven of claim 13 wherein the first shield support structure comprises:
an opening that at least partially receives the IR emitter; and,
a pair of support surfaces positioned on opposite sides of the opening that support opposite sides of the shield.

15. A method of shielding an IR emitter comprising the steps of:
providing a glass oven comprising an IR emitter and a glass bearing device for use in bearing a glass product to be heated by the glass oven, the glass bearing device being supported within the oven;
providing a shield; and,
positioning the shield on a first shield support structure that maintains the shield between the IR emitter and a location within the glass oven occupied by the glass product that is to be heated by the glass oven.

16. The method of claim 15 further comprising the steps of:
providing the glass oven with a first clamp assembly that supports the IR emitter within the glass oven; and,
wherein the step of, positioning the shield on a first shield support structure, comprises the step of attaching the first shield support structure to the first clamp assembly.

17. The method of claim 16 wherein the step of, providing a shield, comprises the step of:
forming the shield from a quartz material.

18. The method of claim 17 wherein the step of, forming the shield from a quartz material, comprises the step of:
cutting a quartz tube.

19. The method of claim 18 wherein the step of, cutting a quartz tube, comprises the step of:
forming first and second shields.

20. The method of claim 16 wherein the step of, attaching the first shield support structure to the first clamp assembly, comprises the steps of:
positioning the IR emitter at least partially within an opening formed in the first shield support structure; and,
resting the shield on a pair of support surfaces formed on the first shield support structure and positioned on opposite sides of the opening.
